(19) United States
(12) Patent Application Publication
(10) Pub. No.: US 2004/0066747 A1
(43) Pub. Date: Apr. 8, 2004

(54) Methods and structure for automated troubleshooting of a virtual private network connection

(76) Inventors: Ben Jorgensen, Overland Park, KS (US); Christopher E. Marschall, Shawnee, KS (US); Michael J. Finazzo, Kansas City, MO (US)

Correspondence Address: LATHROP & GAGE LC, 2345 GRAND AVENUE, SUITE 2800, KANSAS CITY, MO, 64108, US

(21) Appl. No.: 10/262,993

(22) Filed: Oct. 2, 2002

(51) Int. Cl. H04J 1/16; H04L 12/28

(52) U.S. Cl. 370/241; 370/401

(57) ABSTRACT

Methods and systems for automated diagnosis of problems in a VPN connection by an end user of the VPN connection. The invention provides a method for identifying problems in a virtual private network comprising: automatically performing tests of the virtual private network in response to a request from the end user; automatically identifying a problem indicated by analysis of results of the tests, and communicating the identified problem to the end user. The invention provides for communication with the end user in the form of text messages and/or color-coded icons as well as suggested remedies for the identified problem. The invention thereby reduces the load on help-desk/support personnel in resolving common problems in VPN connections by enabling end user self-help without detailed technical training of the end users.

### BACKGROUND OF THE INVENTION

1. Field of the Invention

The present invention relates to diagnosis of computer network connections and more specifically relates to end user diagnosis and troubleshooting for virtual private network (“VPN”) connections.

2. Discussion of Related Art

It is generally known in the art to connect computing systems via telecommunications networks. Such networks are often referred to as local area networks (“LANs”) where the various devices connected to the network are relatively physically proximal. Wide area networks (“WANs”) refer to network connections between devices that are not physically proximal. LAN networks generally utilize direct cabling connections such as Ethernet, token ring, and various forms of optical fiber transmissions to achieve high throughput among a relatively proximal group of devices coupled to the networks. By contrast, WAN technologies generally use local, regional, national or international telecommunications systems including switched telephony, dedicated line telephony and network connections and various forms of wireless communications to interconnect geographically disperse computing elements.

Whether utilizing LAN or WAN technologies, computer networking within a particular enterprise enables computing devices to share information and resources including files, peripheral devices and other system-wide resources. A user at a first computing device within the network can communicate and share resources with one or more other users within the network without necessarily permitting broad access by users outside the computing enterprise. Security measures used in conjunction with such networking help to preclude access to shared resources by users outside the intended computing enterprise.

Virtual private networks (“VPN”) are generally known in the art to bridge the gap between computing resources within an enterprise and users outside the enterprise desirous of connecting to the internal enterprise network. A virtual private network allows a remote user (or group of users) to access the enterprise internal network in a manner that makes the access relatively transparent. The user or users connected to an enterprise network through a VPN connection may utilize the enterprise computing resources on the network in essentially the same manner as if they were physically working within the enterprise. For example, employees may work on site at their employer's computing enterprise using standard LAN or WAN connectivity or may work from home or a remote office utilizing VPN technology to render the actual location of the work being performed essentially irrelevant.

Installation and configuration of the VPN related software on a particular computer involves a number of steps and often requires some detailed knowledge regarding networking parameters and configuration of the underlying enterprise. Although most VPN software products are intended to be installed by an end user, detailed networking knowledge typically required to properly install and configure VPN software is often beyond the capability of typical end users. Information technology management personnel for an enterprise often spend significant resources supporting installation and configuration of VPN software for a number of end users affiliated with the enterprise. Help desk and support technicians are often required to permit an end user to successfully install and configure VPN software. It is therefore a continuing problem to reduce the support load required for assisting end users in installing and configuring VPN software.

Network management tools are known in the art to aid network administrators in centralized management of an enterprise network. Such tools are generally known only for use by centralized network administrators well trained in basic and advanced networking concepts and troubleshooting. Such tools are generally not applicable to untrained end users attempting to install and configure VPN related software on their end user host systems.

It is evident from the above discussion that a need exists for improved methods and systems to enable end users to install, configure and troubleshoot VPN software while reducing the load on support personnel.

### SUMMARY OF THE INVENTION

The present invention solves the above and other problems, thereby advancing the state of the useful arts, by providing systems and associated methods for use thereof to aid users in installing, configuring and troubleshooting networking software.

In one aspect of the invention, a method is provided for identifying problems in a virtual private network. The method comprising: automatically performing tests of the virtual private network in response to a request from an end user; automatically identifying a problem indicated by results of the tests; and communicating said problem to the end user.

In another aspect of the invention, a method is provided for diagnosis of a virtual private network connection operable over a TCP/IP connection by an end user. The method comprising: automatically pinging, responsive to a request by end user, select host systems over the TCP/IP connection to test the virtual private network connection; and indicating to the end user a resolution of any identified problem identified by the pinging.

In another aspect of the invention, a system is provided for identifying problems in a virtual private network connection on an end user's computer. The system comprising: a TCP/IP network connection from the computer to the Internet wherein the virtual private network connection is operable over the TCP/IP network connection; a user interface program operable on the end user's computer to receive user input requesting diagnosis of the virtual private network connection and for reporting identified problems to the end user; an automated test program operably coupled to the user interface program and operable in response to a request from the end user to identify the problems in the virtual private network connection on the TCP/IP connection.

In another aspect of the invention, a system is provided for aiding an end user in identifying problems in a virtual private network connection between the end user's computer and a network. The system comprising: user input means for receiving a request by the end user to diagnose the virtual private network connection; automated testing means to automatically test the virtual private network connection in response to receipt of the request; analysis means for identifying problems from results of the automatic testing; and presentation means for presenting identified problems to the end user.

### BRIEF DESCRIPTION OF THE DRAWINGS

FIG. 1 is a block diagram of an user system using a VPN connection and incorporating automated test features.

FIG. 2 is a flowchart describing a method for automated, end user VPN problem identification.

FIG. 3 is a flowchart describing a method for VPN testing to identify a problem.

FIGS. 4-7 are exemplary computer displays for communicating with an end user to perform automated VPN testing to identify problems.

### DETAILED DESCRIPTION OF EXEMPLARY EMBODIMENTS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

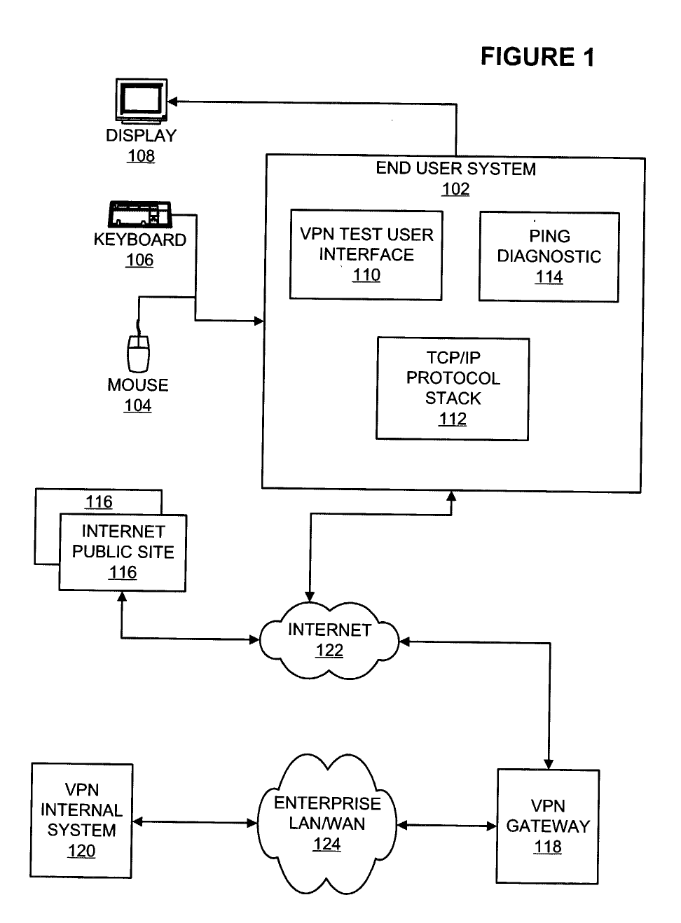

FIG. 1 is a block diagram depicting a system with automated end user VPN diagnosis capabilities. End user system 102 may be any standard computing system including personal computers and workstations, PDAs, and other end user computing systems. Display 108 is coupled to end user system 102 for purposes of presenting information to a user of end user system 102. Keyboard 106 and mouse 104 are coupled to end user system 102 for purposes of receiving user input from a user of end user system 102. Those of ordinary skill in the art will recognize a variety of equivalent system structures including a means for presenting information to an end user such as display 108 and input means for receiving user input such as keyboard 106 and mouse 104.

End user system 102 includes VPN test user interface 110 for interacting with and end user through display 108, keyboard 106 and mouse 104. VPN test user interface 110 receives information from a user of the system including, for example, a request to diagnose VPN connectivity between end user system 102 and another host system within the computing enterprise to which end user system 102 intends to connect using VPN software features. VPN internal system 120 represents such a host system resident within the computing enterprise environment accessible to end user system 102 only through a successful, secure VPN connection.

In particular, VPN test user interface 110 receives a request from an end user of the system to initiate VPN diagnostic procedures to help identify problems in an identified VPN connection. Upon receipt of such a request, VPN test user interface 110 automatically performs test procedures to identify a number of common problems that arise in set up and configuration of a VPN connection. Ping diagnostic 114 is an exemplary diagnostic program that may be utilized by VPN test user interface 110 to provide automated testing of VPN connectivity. The ping program is a standard utility available with most commercial TCP/IP and other network infrastructures including, for example, Microsoft Windows networking features, Linux operating system network features and of the standard networking software bundled with most commercial implementations of the UNIX operating system. Ping diagnostic 114, as is generally known in the art, transmits information packets to an identified host system and receives a response to the transmitted packet to thereby verify communications with the identified host system.

VPN test user interface 110 and ping diagnostic 114 may communicate with other host systems utilizing TCP/IP protocol stack 112. TCP/IP protocol stacks are well known in the art and generally available as commercial networking packages. An exemplary TCP/IP protocol stack is available as a feature of the Microsoft Windows operating systems, Linux operating systems and most commercial implementations of the UNIX operating system. Those of ordinary skill in the art will readily recognize that VPN test user interface 110 may utilize diagnostic test programs other than the ping diagnostic 114 and similarly may use protocol stacks other than TCP/IP protocol stack 112. A variety of other test processes and protocol stacks will be readily apparent to those of ordinary skill in the art.

Utilizing ping diagnostic 114 and TCP/IP protocol stack 112, VPN test user interface 110 within the end user system 102 provides automated features to test VPN connectivity, to identify problems by analyzing the results of such tests, and to present useful information to an end user to aid the end user in resolving identified problems.

As discussed further herein below, VPN test user interface 110 on end user system 102 automatically identifies a number of common problems in VPN connectivity by automatically testing connection to a variety of host systems. VPN network connections often utilize the Internet 122 as a medium through which the virtual private network connection is established. Coupled to the Internet 122 are numerous Internet public sites 116. The VPN Gateway system 118 may also be coupled to Internet 122 to provide a secure virtual private network connection point for the associated enterprise. The computing enterprise to which an end user on end user system 102 is to be connected is represented as enterprise LAN/WAN 124. VPN connections between end user system 102 and enterprise LAN/WAN 124 therefore may utilize connections through Internet 122 and the VPN Gateway system 118. The ultimate purpose of such a virtual private network connection is to provide connections through the Internet (or other wide area network services) to share resources represented as one or more VPN internal host systems 120.

Internet public sites systems 116, VPN Gateway system 118 and VPN internal host systems 120 may all be implemented as standard personal computers, workstations, servers, or other commercially available or customized network nodes and appliances. Further, those of ordinary skill in the art will readily recognize that the configuration and network topology depicted in FIG. 1 is merely exemplary of numerous equivalent network topologies and configurations for coupling an end user system 102 to one or more internal host systems through a virtual private network infrastructure. Use of the Internet and other LAN/WAN communication media and protocols is but one example of a VPN enterprise configuration permitting secure connectivity between an end user system 102 and one or more internal host systems 120.

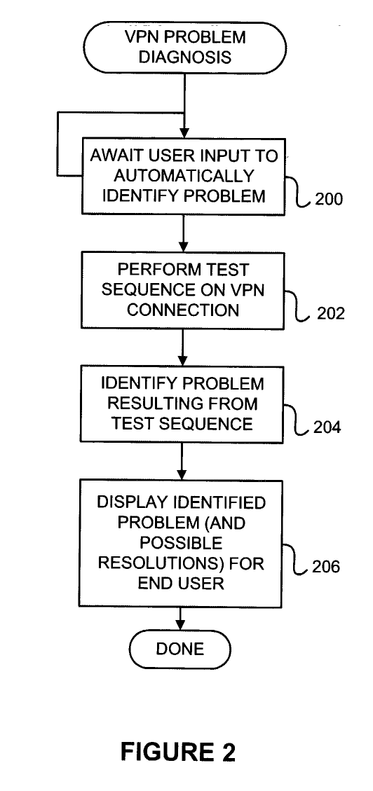

FIG. 2 is a flowchart describing exemplary high-level processing to perform automatic testing and identification of problems in a VPN connection. As described above, the methods may be operable on an end user system as distinct from centralized network management sites and systems. The method aids the unsophisticated, untrained end user in identifying problems with a VPN connection.

Element 200 is first operable to await input from the end user requesting automated assistance in identifying problems in a VPN connection. Responsive to such a user request, element 202 is next operable to automatically perform test sequences on an identified VPN connection associated with the end user's host system.

As discussed further herein below, the automated test includes testing connectivity to a number of host systems involved in the ultimate connection to a desired internal host system within the secured VPN enterprise. The particular VPN connection, and the various intermediate and final host systems involved in the connectivity may be provided as input by the end user, or may be preconfigured in a configuration file or database queried by the automated test procedures. Such a configuration file or database may be generated and stored locally on the end user's host system or may be generated and/or stored remotely on other network nodes of the enterprise. Still further, the configuration information may be obtained from configuration files associated with the VPN connection per se (i.e., configuration information generated and stored by the VPN related components independent of the automated testing aspects of the invention).

Element 204 identifies potential problems (if any) in the VPN connection identifiable from analysis of the results of the test sequences performed by element 202. Lastly, element 206 displays any problems so identified and may further provide suggested resolutions of such identified problems for the end user. Exemplary solutions may include, for example, indicating that the DNS server is not properly responding and that the DNS configuration of the TCP/IP protocols should be corrected. Or may include, for example, indicating that the VPN gateway is not properly responding and that the VPN configuration information should be corrected to properly identify the VPN gateway. Numerous other possible problem resolutions that may be suggested to the end user will be readily apparent to those of ordinary skill in the art.

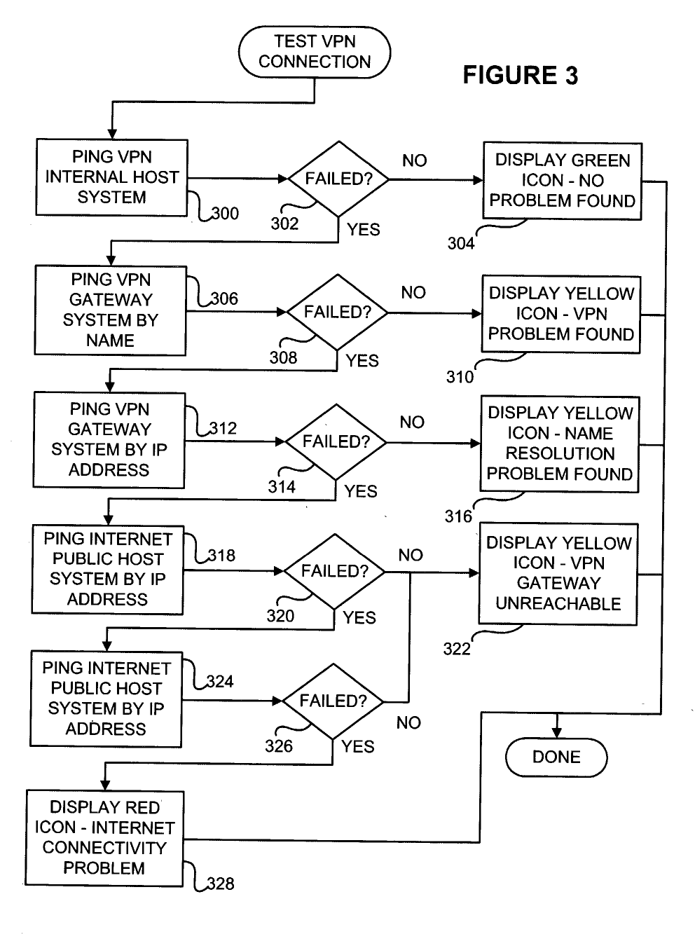

FIG. 3 is a flowchart providing additional details of the combined operation of elements 202, 204 and 206 of FIG. 2. The method of the flowchart of FIG. 3 is therefore operable to perform automated test sequences on a VPN connection, to identify problems arising from the automated test sequences and to provide information to the end user describing the identified problems and, optionally, potential resolutions to any such identified problems. Element 300 is first operable to “ping” an identified VPN internal host system. “Ping” is used as a verb herein to indicate the process of running an appropriate program to test communication with an identified host system. A typical program used for such a purpose would generate a transmission to the identified host system and await receipt of an appropriate, corresponding response to that communication. The ping program noted above as a standard component associated with most TCP/IP software packages and networked operating systems is an example of such a diagnostic program as associated with TCP/IP protocols. Other equivalent diagnostic programs may be used for the same purpose within TCP/IP protocols. Still further, equivalent programs will be readily apparent to those of ordinary skill in the art for application with other networking protocols. Still further, as used herein, the verb “ping” represents the automated operation of such a diagnostic program without requiring specific parameters or input from the end user for the particular ping operation. Such automated processing obviates the need for and end user to be trained in details of network configuration and operation.

Element 302 next analyzes the status information returned by the ping operation of element 300 to determine whether the ping succeeded or failed. If element 302 determines that the pinging of the internal host system by element 300 failed, processing continues at element 306 as described below. If the ping operation succeeded, element 304 is operable to display information to the end user indicating that no problem was identified by the automated test process. In one aspect of the invention, a green color-coded icon may be displayed on the end user's computer display to indicate success of the test operation and successful connectivity to the identified VPN internal host system. In yet another aspect the green icon may be represented as a green light on a traffic light icon symbol. Further, element 304 may present information in the form of textual status resulting from the operation of element 300. For example, a window on the end user's display may present textual information from operation of a ping program by element 300. Such a textual display may be in addition to, or in lieu of, the icon displayed as noted above. Following presentation of the successful test information by element 304, processing of the method may complete.

If element 302 determines that the ping operation of element 300 failed, element 306 is next operable to ping an identified VPN Gateway system associated with connectivity to the identified VPN internal host system. More specifically, element 306 may use the symbolic host name of the VPN Gateway system in accordance with standard TCP/IP symbolic naming conventions. Element 308 next determines whether the ping operation of element 306 succeeded or failed. If the analysis of element 308 determines that the ping operation succeeded, element 310 is next operable to display the identified problems to the end user. In this case, the identified problems relates to identification or accessibility of the VPN internal host system discussed above with respect to element 300. Where the ping operation of element 300 was unsuccessful but they ping operation of element 306 was successful, the problem lies not in access to the VPN Gateway but rather more specifically lies in access to the identified VPN internal host system. In other words, the VPN Gateway system is accessible but not the identified VPN internal host system. Element 310 therefore presents such a problem identification to the end user. In one aspect of the invention, information is presented as a yellow color-coded icon suggesting a VPN internal host system problem has been identified. More specifically, in one aspect of the invention, the yellow icon may be presented as a yellow light in a traffic light graphic icon. Further, as noted above, another aspect of the invention presents textual status information returned by the ping operation of element 306 either in lieu of or in addition to the yellow icon information presented to the user. Following display of identified problem information to the user by operation of element 306, the method may complete.

Where element 308 determines that the ping operation of element 306 failed, element 312 is next operable to ping the identified VPN Gateway system using the fixed or static IP address rather than the symbolic name used above in element 306. Element 314 then determines whether the ping operation of element 312 succeeded or failed. If the analysis of element 314 determines that the ping operation of element 312 succeeded, element 316 is operable to display the identified problem to the end user. In particular, in this situation, the identified problem relates to name resolution within the end user's network configuration. The analysis in this example determines that the VPN Gateway system is not accessible using a symbolic name but is accessible using a fixed IP address. In such a case, the likely problem relates to TCP/IP domain name services (“DNS”) configuration errors. As above, this identified problem may be presented to the user in textual form, color-coded iconic graphic form, or both. In one aspect of the invention, a yellow icon is presented to the end user to indicate identification of a correctable DNS configuration error. In another exemplary embodiment, such a yellow icon is presented to the user as a yellow light in a traffic light graphic icon. Following presentation of the identified problem information and potential resolutions thereof by processing of element 316, the method may complete.

If element 314 determines that the ping operation of element 312 failed, element 318 is next operable to ping a public host system on the Internet using a fixed IP address to identify the public host system. Element 320 then analyzes the output of the ping operation of element 318 to determine whether the ping operation succeeded or failed. If the analysis of element 320 determines that the ping operation of element 318 succeeded, the problem so identified is then presented to the user by operation of element 322. In this example, the problem so identified indicates that the VPN Gateway is unreachable. Success of the ping operation of element 318 indicates that TCP/IP access to the Internet is generally operable. However, failure of previous ping operations (element 300, 306 and 312) indicates that the VPN Gateway system is not accessible through the Internet using either its identified symbolic name or its identified fixed IP address. As above, such an identified problem may be presented to the user by element 322 either textually, using iconic graphics, or both. In one aspect of the invention a yellow icon may be used to indicate detection of a correctable VPN configuration error, namely, the VPN Gateway host system is improperly identified, both by name and fixed IP address. Following presentation of the identified problem to the end user by operation of element 322, the method may complete.

If element 320 determines that the ping operation of element 318 failed, element 324 is operable to ping another public host system on the Internet using a fixed IP address. It is possible that the ping operation of element 318 failed because the particular identified public host system on the Internet was temporarily unavailable. Element 324 therefore attempts to ping a second public host system on the Internet using its fixed IP address. Element 326 then analyzes the results of the ping operation of element 324 to determine success or failure thereof. If the analysis of element 326 determines that the ping operation of element 324 succeeded, processing continues with element 322 as above to present the user with information identifying the problem as an unreachable VPN Gateway. If the analysis of element 326 determines that the ping operation of element 324 failed, element 328 is operable to present the identified problem to the end user. In this example, the problem identified is a failure of Internet connectivity from the end user's system. Where the ping operation of each of two (or more) public host systems normally accessible through the Internet failed, the likely problem for the user's VPN connectivity is lack of an appropriate Internet connection. As above, the identified problem may be presented to the user textually, using color-coded graphic icons, or both. In one aspect of the invention a red color-coded icon is presented to the user to indicate failure of Internet connectivity. In another aspect of the invention the red icon is presented as a red light in a traffic light icon symbol. Following presentation of the identified problem to the end user by processing of element 328, processing of the method may complete.

Those of ordinary skill in the art will recognize a variety of sequences of host systems that may be tested to identify likely problems in the end user's VPN connectivity. The particular sequence of host systems described by FIG. 3 and the particular problems identified thereby are merely exemplary of one possible such sequence and method. For example, the number of Internet public sites tested may be altered. Still further, access of various hosts may be by name only, by IP address only, or both.

Further, those of ordinary skill in the art will note, as described above, that the particular host systems to be tested may-be identified in a configuration file or database associated with the automated test procedure. Further, the host system identification information may be obtained from configuration files or database associated with the VPN software per se. In other words, such host identification information need not be duplicated both in the VPN configuration files or databases and a separate configuration file or database associated with the test process. Rather, the automated test process may extract useful information from the VPN configuration files or database.

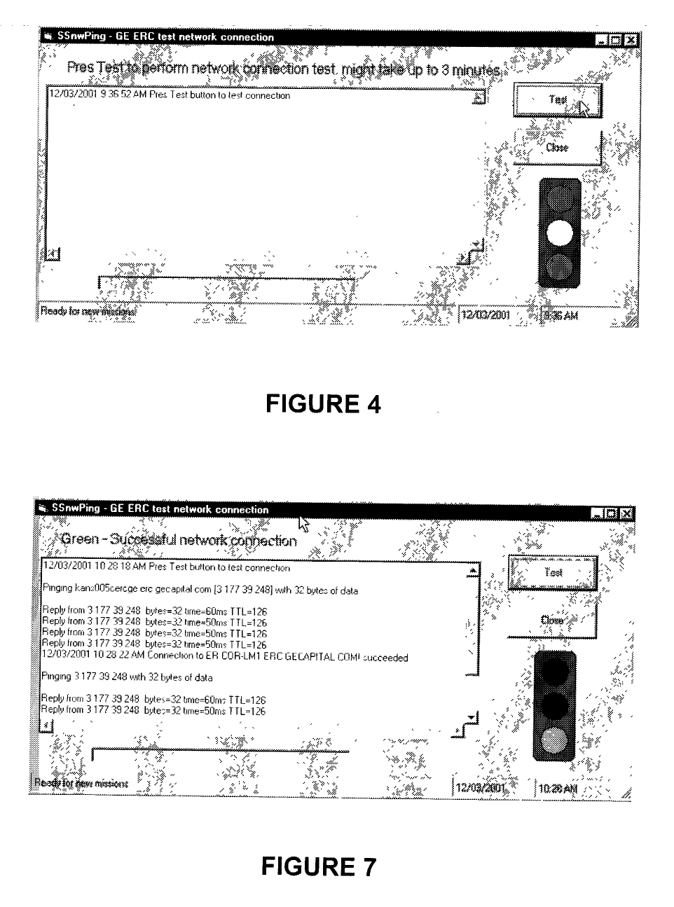

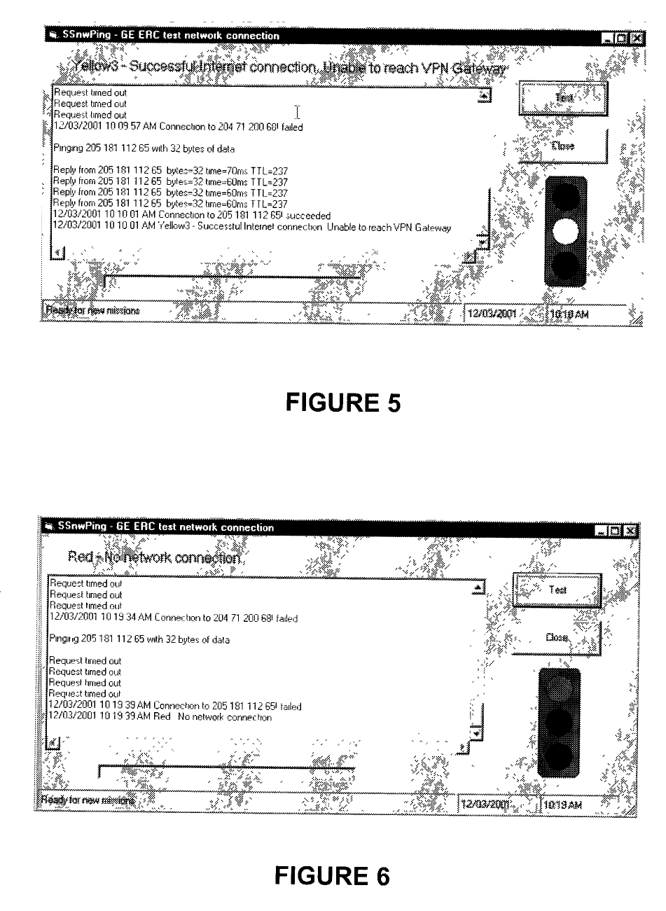

FIGS. 4 through 7 are display screen images corresponding to one exemplary embodiment of the invention. In particular, FIG. 4 shows a first screen presented to an end user when the test program is initiated. The user is prompted to press the test button to commence the VPN connectivity test. A close button may be used to cancel the process and close the test program. A traffic light icon may be presented to the user with no lights lit to indicate that the test has not yet proceeded. FIG. 5 is a second exemplary screen display for an end user where an identified problem indicates that the VPN Gateway is unreachable (as discussed above). Such a problem may be identified by a textual display, or a color-coded icon graphic display, or both. As shown in FIG. 5, textual information indicates that analysis of the testing shows connectivity to the Internet but no connection to the configured VPN internal host system or VPN Gateway system. A yellow icon indicates such a correctable, identified problem in the VPN software configuration. In particular, a yellow traffic light symbol easily identifies such a correctable problem. The textual display may further provide the user with suggested resolutions for such a problem.

FIG. 6 provides another exemplary screen display where the identified problem indicates failure of the Internet connection. Such a problem may be indicated by a textual display, or a color-coded graphic icon, or both. The textual display of FIG. 6 may indicate to the user failure of communications with all identified systems including the VPN internal host, the VPN Gateway and a number of public host systems usually available on the Internet. The textual display may also provide the user with suggested resolutions of such an identified problem such as contacting the Internet service provider (“ISP”) or other appropriate support personnel to resolve the Internet connection problem. A red color-coded icon is displayed to easily identify such a total failure of Internet communications.

FIG. 7 is an exemplary screen display used to indicate success of the connectivity test for an end user. Such successful test completion may be indicated to the end user by a textual display, a color-coded graphic icon, or both. The textual display indicates to the user that communications to an identified internal host system of the VPN was successful (as well as communications with other identified systems including the VPN Gateway and a number of public host systems generally unavailable on the Internet). In addition, a green graphic icon may be used to rapidly and easily communicate to the user success of the conductivity test. Still further a traffic light graphic icon with a green light easily communicates such a successful test operation.

Those of ordinary skill in the art will recognize that the exemplary screen displays of FIGS. 4 through 7 are representative of one possible exemplary embodiment of the invention. Numerous other equivalent displays and presentations may be used to rapidly and easily communicate test information to an end user. In particular, the presentation may be adapted to easily communicate with an untrained user to identify complex network configuration and operation problems in a simple, easy to read, easy to understand manner. Numerous equivalent displays will be readily apparent to those of ordinary skill in the art to achieve this purpose.

Further, those of ordinary skill in the art will recognize a wide variety of indicia that may be presented to the end user to easily communicate the identified problem to an unsophisticated end user. As above, textual information and/or color-coded graphical icons may be one form of such indicia. Numerous other equivalent indicators will be readily apparent to those of ordinary skill in the art.

While the invention has been illustrated and described in the drawings and foregoing description, such illustration and description is to be considered as exemplary and not restrictive in character, it being understood that only the preferred embodiments and minor variants thereof have been shown and described and that all changes and modifications that come within the spirit of the invention are desired to be protected.

What is claimed is:

1. A method for identifying problems in a virtual private network comprising:
automatically performing tests of said virtual private network in response to a request from an end user;
automatically identifying a problem indicated by results of said tests; and
communicating said problem to said end user.

2. The method of claim 1 wherein the step of communicating said problem includes the step of:
displaying a color-coded icon to indicate the severity of said problem.

3. The method of claim 2 wherein the step of displaying comprises the step of:
displaying a red icon to indicate an error that precludes further testing to identify said problem.

4. The method of claim 2 wherein the step of displaying comprises the step of:
displaying a yellow icon to indicate identification of said problem.

5. The method of claim 2 wherein the step of displaying comprises the step of:
displaying a green icon to indicate the absence of any identified problem.

6. The method of claim 2 wherein the step of displaying comprises the step of:
displaying a traffic light icon wherein said traffic light icon appears with a red light to indicate an error that precludes further testing to identify said problem and wherein said traffic light icon appears with a yellow light to indicate identification of said problem and wherein said traffic light appears with a green light to indicate the absence of any identified problem.

7. The method of claim 1 wherein the step of automatically performing tests comprises the step of running a ping utility.

8. The method of claim 7 wherein the step of running said ping utility comprises the step of pinging a plurality of host systems.

9. The method of claim 8 wherein the step of pinging a plurality of host systems comprises the steps of:
first pinging an internal host system;
determining that said first pinging failed;
second pinging a VPN gateway host system by name in response to the determination that said first pinging failed;
determining that said second pinging failed;
third pinging said VPN gateway host system by IP address in response to the determination that said second pinging failed;
determining that said third pinging failed;
fourth pinging a first public Internet host system by IP address in response to the determination that said third pinging failed;
determining that said fourth pinging failed;
fifth pinging a second public Internet host system by IP address in response to the determination that said fourth pinging failed; and
determining that said fifth pinging failed.

10. The method of claim 9 wherein the step of automatically identifying said problem comprises the step of:
identifying a VPN connectivity problem as said problem in response to failure of said first pinging and success of said second pinging and success of said third pinging and either success of said fourth pinging or success of said fifth pinging.

11. The method of claim 9 wherein the step of automatically identifying said problem comprises the step of:
identifying a VPN gateway connectivity problem as said problem in response to failure of said first pinging and failure of either said second pinging or said third pinging and either success of said fourth pinging or success of said fifth pinging.

12. The method of claim 9 wherein the step of automatically identifying said problem comprises the step of:
identifying an Internet connectivity problem as said problem in response to failure of said first pinging and failure of said second pinging and failure of said third pinging and failure of said fourth pinging and failure of said fifth pinging.

13. A method for diagnosis of a virtual private network connection operable over a TCP/IP connection by an end user comprising:
automatically pinging, responsive to a request by said end user, select host systems over said TCP/IP connection to test said virtual private network connection; and
indicating to said end user a resolution of any identified problem identified by said pinging.

14. The method of claim 13 wherein the step of pinging select host systems comprises the steps of:
pinging an Internet public host system through said TCP/IP; and
identifying an Internet connectivity problem in response to failure of said pinging of said Internet public host system.

15. The method of claim 14 wherein the step of indicating comprises the step of:
displaying a red indicator to said end user to indicate Internet connectivity failure.

16. The method of claim 14 wherein the step of pinging select host systems further comprises the steps of:
responsive to success of said pinging of said Internet public host system, performing the additional steps of:
pinging a VPN gateway host system by IP address through said TCP/IP connection; and
identifying a VPN gateway problem in response failure of said pinging of said VPN gateway host system by IP address.

17. The method of claim 16 wherein the step of indicating comprises the step of:
displaying a yellow indicator to said end user to indicate a VPN gateway failure.

18. The method of claim 16 wherein the step of pinging select host systems further comprises the steps of:
responsive to success of said pinging of said VPN gateway host system by IP address, performing the additional steps of:
pinging said VPN gateway host system by name through said TCP/IP connection; and
identifying a name resolution problem in response failure of said pinging of said VPN gateway host system by name.

19. The method of claim 18 wherein the step of indicating comprises the step of:
displaying a yellow indicator to said end user to indicate a name resolution failure.

20. The method of claim 18 wherein the step of pinging select host systems further comprises the steps of:
responsive to success of said pinging of said VPN gateway host system by name, performing the additional steps of:
pinging an internal host system through said TCP/IP connection; and
identifying a VPN problem in response failure of said pinging of said internal host system.

21. The method of claim 20 wherein the step of indicating comprises the step of:
displaying a yellow indicator to said end user to indicate a VPN failure.

22. The method of claim 20 wherein the step of indicating comprises the step of:
responsive to success of said pinging of said internal host system, performing the additional steps of:
displaying a green indicator to said end user to absence of a virtual private network connection problem.

23. A system for identifying problems in a virtual private network connection on an end user's computer, said system comprising:
a TCP/IP network connection from said computer to the Internet wherein said virtual private network connection is operable over said TCP/IP network connection;
a user interface program operable on said end user's computer to receive user input requesting diagnosis of said virtual private network connection and for reporting identified problems to said end user;
an automated test program operably coupled to said user interface program and operable in response to a request from said end user to identify said problems in said virtual private network connection on said TCP/IP connection.

24. The system of claim 23 wherein said automated test program comprises:
a diagnostic program operable to communicate with select host systems to identify said problems.

25. The system of claim 24 wherein said diagnostic program comprises:
a ping protocol compliant program to exchange ping packets with said select host systems to identify said problems by said exchange.

26. A system for aiding an end user in identifying problems in a virtual private network connection between the end user's computer and a network, said system comprising:
user input means for receiving a request by said end user to diagnose said virtual private network connection;
automated testing means to automatically test said virtual private network connection in response to receipt of said request;
analysis means for identifying problems from results of the automatic testing; and
presentation means for presenting identified problems to said end user.

27. The system of claim 26 wherein the user input means includes:
a keyboard for receiving textual input from said end user.

28. The system of claim 26 wherein the user input means includes:
a pointer device for receiving input from said end user.

29. The system of claim 26 wherein the presentation means includes:
a display for displaying information regarding the identified problems.

30. The system of claim 29 wherein the display includes:
a textual display window for displaying text messages indicative of the identified problems.

31. The system of claim 29 wherein the display includes:
a color-coded icon display area for displaying a graphical icon indicative of the identified problems.

32. The system of claim 31 wherein said color-coded display area is coded green in response to the analysis means identifying no problems and wherein said color-coded display area is coded yellow in response to the analysis means identifying problems in VPN configuration and wherein said color-coded display area is coded red in response to the analysis means identifying problems with Internet connectivity.

33. The system of claim 32 wherein said color-coded display area is a graphical representation of a traffic light.

34. The system of claim 26 further including:
an Internet connection over which said virtual private network connection is operable.

35. The system of claim 34 wherein said automated testing means includes:
means for pinging selected host systems using said Internet connection.

36. The system of claim 35 wherein said means for pinging is operable to ping an Internet public site host system and wherein said analysis means is operable to identify Internet connectivity as the identified problem in response to failure of said ping.

37. The system of claim 35 wherein said means for pinging is operable to ping a VPN gateway host system and wherein said analysis means is operable to identify VPN configuration as the identified problem in response to failure of said ping.

38. The system of claim 35 wherein said means for pinging is operable to ping a VPN gateway host system using the symbolic name of the VPN gateway host system and wherein said analysis means is operable to identify DNS configuration as the identified problem in response to failure of said ping.

39. The system of claim 35 wherein said means for pinging is operable to ping a VPN internal host system and wherein said analysis means is operable to identify VPN configuration as the identified problem in response to failure of said ping.
